(19) United States
(12) Patent Application Publication
(10) Pub. No.: US 2022/0398910 A1
(43) Pub. Date: Dec. 15, 2022

(54) OCCUPANT TRAFFIC OPTIMIZATION

(71) Applicant: Johnson Controls Fire Protection LP, Boca Raton, FL (US)

(72) Inventor: John Bradley STOWELL, Westminster, MA (US)

(21) Appl. No.: 17/836,450

(22) Filed: Jun. 9, 2022

Related U.S. Application Data
(60) Provisional application No. 63/209,753, filed on Jun. 11, 2021.

(51) Int. Cl. G08B 21/02; G08B 7/06

(52) U.S. Cl. CPC G08B 21/02; G08B 7/06

(57) ABSTRACT

An aspect of the present disclosure includes a notification device configured for mounting on a surface including a projector configured to display light patterns on the surface; a projection control module (PCM) communicatively coupled with the projector, wherein the PCM is configured to receive, from a control panel, a message in response to a number of occupants exceeding an occupant threshold in a zone of an infrastructure; and cause the projector to display at least a portion of the message on the surface using the light patterns.

### CROSS-REFERENCE TO RELATED APPLICATIONS

The current application claims priority to, and the benefit of, U.S. Provisional Application No. 63/209,753 filed Jun. 11, 2021 and entitled “OCCUPANT TRAFFIC OPTIMIZATION,” the contents of which are hereby incorporated by reference in their entireties.

### BACKGROUND

Conventional infrastructures may include numerous alarm notification devices that provide basic warnings (e.g., activating siren, audio, and/or flashing strobes) to occupants of the infrastructures during occurrences of hazard (e.g., fire, intruder in the infrastructures, power outage, etc.). However, the conventional alarm notification devices may be unable to meet the demands necessary for combatting new public health hazards, such as social distancing requirements and limitations on occupant capacity. Although there exists dynamic notification devices, it may be prohibitively expensive and time-consuming to install enough dynamic notification devices throughout an infrastructure to ensure that most, if not all, occupants are able to access detailed warnings or instructions. Therefore, improvements in mass notification and occupant guidance may be desirable.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

Certain aspects of the present disclosure includes a notification system in an infrastructure including a control panel, at least one occupant sensor communicatively coupled with the control panel and configured to determine a number of occupants in each of at least one zone in the infrastructure, and a notification device and communicatively coupled with the control panel, wherein the control panel is configured to receive an indication signal from the at least one occupant sensor indicating the number of occupants in a corresponding zone of the at least one zone, obtaining an occupant threshold associated with the corresponding zone, determining whether the number of occupants exceeds the occupant threshold, generating a message in response to the number of occupants exceeding the occupant threshold, transmit the message to the notification device, and wherein the notification device is configured to receive the message from the control panel, and display at least a portion of the message.

In one aspect of the present disclosure, the control panel may receive, compile, monitor, and/or analyze occupant sensor data. The control panel may maintain historical occupant data (e.g., occupant counts and/or traffic patterns) to generate one or more reports to facility personnel associated with the infrastructure.

In another aspect of the present disclosure, the control panel may analyze occupant data to identify usage data (e.g., number of occupants, time of occupancy) in various areas of the infrastructure. Based on the usage data, the control panel may manage and/or reduce energy consumption (e.g., reduce light and/or air conditioning/heat when the number of occupants reduces below a certain threshold), organizing cleaning and/or maintenance (e.g., dispatching cleaning crew when the number of occupants reduces below a certain threshold), pre-determine traffic patterns, and/or identify occupant information (e.g., number of occupants at various times, foot traffic patterns, etc.).

### BRIEF DESCRIPTION OF THE DRAWINGS

The features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 illustrates an example of an environment for implementing one or more notification device in accordance with aspects of the present disclosure;

FIG. 2 illustrates an example of a frontal view of a notification device in accordance with aspects of the present disclosure;

FIG. 3 illustrates an example of a method for mass notification in accordance with aspects of the present disclosure;

FIG. 4 illustrates an example of a method for displaying a message in accordance with aspects of the present disclosure; and

FIG. 5 illustrates an example of a computer system in accordance with aspects of the present disclosure.

### DETAILED DESCRIPTION

According to aspects of the present disclosure, using message notification devices with existing alarm notification devices may create a live platform for mass notifications and instructions within a building. Aspects of the present disclosure may capitalize on the distributed notification devices to monitor the number of occupants and/or control the flow of occupant traffic in the building. By relying on the live platform, occupants may remain vigilant and aware of the number of occupants in the building. By constantly analyzing the environment throughout the entire building, the message notification devices may update and display the safest strategy tailored for every section of the building. In some implementations, the notification devices may also provide visual aids and instructions for audible-impaired occupants. In some implementations, the notification devices may also display non-emergency notifications such as public announcements, visual advertisements, videos, or other marketing collateral when the emergency mass notification system is not in use.

In certain aspects, the notification devices may display messages via a display (e.g., liquid crystal display (LCD), light emitting diode (LED) display, flat panel display, projection display, etc.).

The message notification devices for retrofitting the alarm notification devices may conform to the National Fire Protection Association (NFPA) standard.

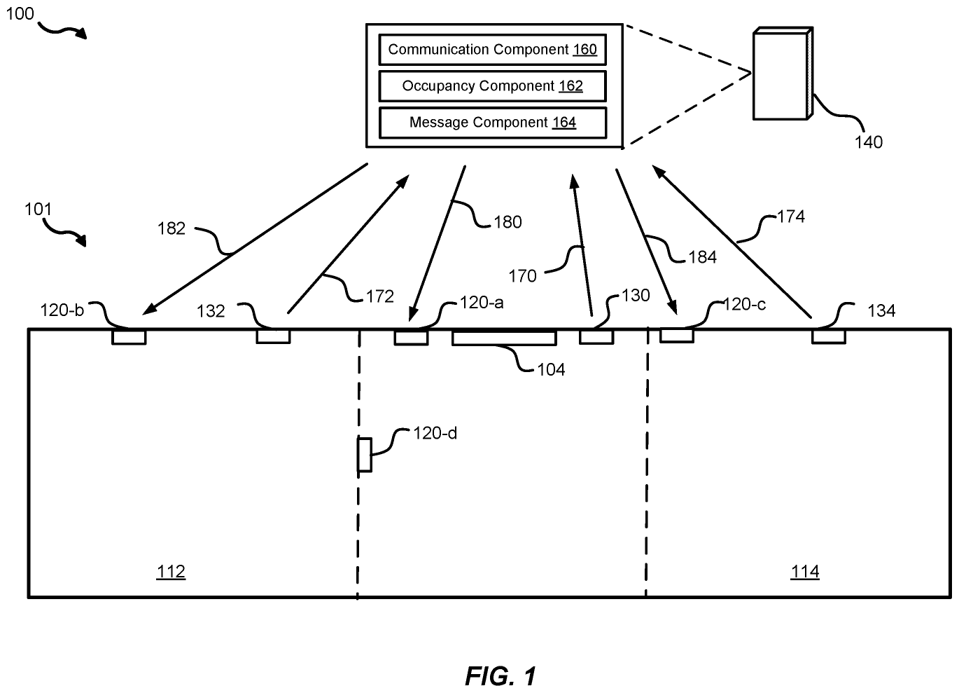

Turning now to FIG. 1, a top-view of an infrastructure 101 may illustrate an example of an environment 100 for mass notification. The environment 100 may include the infrastructure 101. The infrastructure 101 may include one or more zones, such as zones 112, 114. Each of the zones 112, 114 may be a room, a compartment, a closet, a hall, a hallway, a stairwell, a lobby, or other indoor and/or outdoor spaces. The infrastructure 101 may have an entrance 104 for ingress into and egress out of the infrastructure 101. The environment 100 may include one or more notification devices 120 configured to receive notifications messages and/or display messages (e.g., by displaying on a LCD, a LED display, a flat panel display and/or projecting onto a surface), such as notification devices 120-a, 120-b, 120-c. The notification devices 120-a, 120-b, 120-c may be placed in compliance with one or more local or national standards, such as the NFPA standard. The notification devices 120-a, 120-b, 120-c may be placed on or display/project onto the walls of the infrastructure 101. The notification devices 120-a, 120-b, 120-c may be placed at “eye level,” or between 5-9 feet above the floor.

In an implementation, the environment 100 may include one or more occupant sensors configured to detect a number of occupants entering, exiting, and/or in one or more of the zones 112, 114 of the infrastructure, such as occupant sensors 130, 132, 134. Examples of the occupant sensors 130, 132, 134 may include a passive infra-red detector, an imaging camera, a horizontal beam sensor, or a turnstile counter. In one aspect of the present disclosure, each of the occupant sensors 130, 132, 134 may include a unique identifier.

In some implementations, the environment 100 may include a control panel 140 for receiving a number of occupants and/or transmitting messages to be displayed by the notification devices 120-a, 120-b, 120-c. In some examples, the control panel 140 may be a standalone panel, a fire panel, or a computer device. The control panel 140 may be local or remote to the infrastructure 101. The control panel 140 may include a communication component 160 for receiving occupant information (e.g., a number of occupants) from the occupant sensors 130, 132, 134. The communication component 160 may transmit messages to be displayed by the notification devices 120-a, 120-b, 120-c. The control panel 140 may include an occupancy component 162 that analyzes whether a number of occupants in the one or more of the zones 112, 114 has exceeded a corresponding occupancy threshold. The control panel 140 may include a message component 164 that generates messages. In one example, the messages provided by the control panel 140 may include an indication that the number of occupants in the one or more of the zones 112, 114 exceeds an occupancy threshold. The messages may be transmitted to the notification devices 120-a, 120-b, 120-c by the control panel 140. Alternatively, the messages may be stored in the notification devices 120-a, 120-b, 120-c. The control panel 140 may transmit an indication selecting one or more of the stored messages for display depending on the analysis of the number of occupants. In one implementation, the control panel 140 may transmit the same message to the notification devices 120-a, 120-b, 120-c. In another implementation, the control panel 140 may transmit different messages to the notification devices 120-a, 120-b, 120-c. A subset of the notification devices 120-a, 120-b, 120-c may display a first message and a different subset of the notification devices 120-a, 120-b, 120-c may display a second message different from the first message (e.g., “occupancy over the limit,” “please exit via the side door”).

During normal operation, people may enter the infrastructure 101 via the entrance 104. The first occupant sensor 130 may track the number of people entering the infrastructure 101. Alternatively or additionally, the first occupant sensor 130 may measure the number of occupants in the infrastructure 101. An infrastructure occupant threshold may be associated with the infrastructure 101. The infrastructure occupant threshold may indicate a maximum number of occupants allowed or recommended to occupy the infrastructure 101 due to governmental regulations, health codes, building codes, safety standards, or other factors. The first occupant sensor 130 may transmit a first indication signal 170 to the control panel 140 indicating the number of occupants in the infrastructure 101. The occupancy component 162 may compare the number of occupants with the infrastructure occupant threshold. If the number of occupants in the infrastructure 101 exceeds the infrastructure occupant threshold, the occupancy component 162 may indicate that the number of occupants in the infrastructure 101 exceeds the infrastructure occupant threshold. In response, the message component 164 may generate message 180, 182, 184. The communication component 160 and/or the control panel 140 may transmit the messages 180, 182, 184 to the notification devices 120-a, 120-b, 120-c. The messages 180, 182, 184 may include one or more of the number of occupants in the infrastructure 101 (e.g., “105 people”), the infrastructure occupant threshold (e.g., “100 people”), a number of occupants in excess of the infrastructure occupant threshold (e.g., “5 people”), an instruction for the occupants to leave the infrastructure 101 (e.g., “Please Exit The Building”), a direction for the occupants to leave the infrastructure 101 (e.g., “Please Exit Through The Main Entrance”), or other relevant information. One or more of the notification devices 120-a, 120-b, 120-c may display the messages 180, 182, 184. The messages 180, 182, 184 may be identical or different.

In one aspect of the present disclosure, the control panel 140 may transmit different messages to the notification devices 120-a, 120-b, 120-c. For example, the first message 180 may include the message “Please Exit Through The Main Entrance.” The second message 182 may include the message “Please Exit to Your Right.” The third message 184 may include the message “Please Exit to Your Left.”

In some implementations, some of the occupants may enter the first zone 112. A first occupant threshold may be associated with the first zone 112. The first occupant threshold may indicate a maximum number of occupants allowed or recommended to occupy the first zone 112 due to governmental regulations, health codes, building codes, safety standards, or other factors. The second occupant sensor 132 may transmit a second indication signal 172 to the control panel 140 indicating the number of occupants in the first zone 112. The occupancy component 162 may compare the number of occupants in the first zone 112 with the first occupant threshold. If the number of occupants in the first zone 112 exceeds the first occupant threshold, the occupancy component 162 may indicate that the number of occupants in the first zone 112 exceeds the first occupant threshold. In response, the message component 164 may generate the second message 182. The communication component 160 and/or the control panel 140 may transmit the second message 182 to the second notification device 120-b. The second message 182 may include one or more of the number of occupants in the first zone 112 (e.g., “27”), the first occupant threshold (e.g., “20”), a number of occupants in excess of the first occupant threshold (e.g., “7”), an instruction for the occupants to leave the first zone 112 (e.g., “Please Exit The Conference Room,” “7 People Need to Exit the Conference Room”), a direction for the occupants to leave the first zone 112 (e.g., Please Exit The Conference Room Through The Side Door”), or other relevant information. The second notification device 120-b may display the message 182.

In one aspect of the present disclosure, the second indication signal 172 may include the second identifier associated with the second occupant sensor 132. When the control panel 140 receives the second indication signal 172 indicating the number of occupants, the control panel 140 may be able to determine that the received number of occupants is associated with the first zone 112 based on the second identifier. As a result, the control panel 140 may determine to send the second message 182 to the second notification device 120-b.

In some implementations, some of the occupants may enter the second zone 114. A second occupant threshold may be associated with the second zone 114. The second occupant threshold may indicate a maximum number of occupants allowed or recommended to occupy the second zone 114 due to governmental regulations, health codes, building codes, safety standards, or other factors. The third occupant sensor 134 may transmit a third indication signal 174 to the control panel 140 indicating the number of occupants in the second zone 114. The occupancy component 162 may compare the number of occupants in the second zone 114 with the second occupant threshold. If the number of occupants in the second zone 114 exceeds the second occupant threshold, the occupancy component 162 may indicate that the number of occupants in the second zone 114 exceeds the second occupant threshold. In response, the message component 164 may generate the third message 184. The communication component 160 and/or the control panel 140 may transmit the third message 184 to the third notification device 120-c. The third message 184 may include one or more of the number of occupants in the zone 112 (e.g., “Current Capacity: 41”), the first occupant threshold (e.g., “Maximum Capacity: 40”), a number of occupants in excess of the first occupant threshold (e.g., “1 Person Exceeding Capacity”), an instruction for the occupants to leave the zone 112 (e.g., “Please Exit the Dining Hall While Maintaining Social Distancing”), a direction for the occupants to leave the zone 112 (e.g., Please Exit the Dining Hall Through Exit Only”), or other relevant information. The second notification device 120-b may display the message 182.

In some implementations, the occupant sensors 130, 132, 134 and/or the control panel 140 may periodically examine the number of occupants in the infrastructure 101 (e.g., every 30 seconds, every minute . . . ). In other implementations, the occupant sensors 130, 132, 134 and/or the control panel 140 may examine the number of occupants when there is a change in the number of occupants.

In certain aspects of the present disclosure, aspects of the present disclosure may be utilized to monitor and/or track the flow of occupants and/or pedestrians at various locations and/or times. For example, the control panel 140 may store (in an internal or external memory) the time and/or number of occupants entering and/or exiting the infrastructure 101, the first zone 112, and/or the second zone 114. Based on the information, the control panel 140 may predict pedestrian flow and/or direct occupants (via audio and/or visual notifications) in and/or out of the infrastructure 101. Management personnel of the infrastructure 101 may set occupancy constraints, preferences, and/or limits via the control panel 140. The control panel 140 may continuously monitor and/or optimize the infrastructure 101 to reduce the need for human intervention.

In a first example implementation, the control panel 140 may be placed in a stadium. The stadium may include a number of notification devices (such as notification devices 120) and a number of occupant sensors (such as occupant sensors 132). After an event (e.g., sports games, concerts, conventions), the control panel 140 may detect (via the number of occupant sensors) the distribution, concentration, and/or movements of event attendees via the number of occupant sensors. Based on the detection, the control panel 140 may direct (via the number of notification devices) the attendees into the stadium before the beginning of the event and/or out of the stadium after the end of the event. Specifically, the control panel 140 may direct the attendees from more crowded entrances/exits to alternate (less crowded) entrances/exits.

In a second example implementation, the control panel 140 may be placed in a public transportation terminal (e.g., airports, train stations). The terminal may include a number of notification devices (such as notification devices 120) and a number of occupant sensors (such as occupant sensors 132). The control panel 140 may receive information associated with public transportations (e.g., commercial flight and/or train schedules). When a flight and/or train arrives, the control panel 140 may display the arrival information (e.g., arrival time, gate number, take-off time, etc.) and/or direction to the gate of the arriving flight or the platform of the arriving train.

In a third example implementation, the control panel 140 may be placed in a building. The building may include a number of notification devices (such as notification devices 120) and a number of occupant sensors (such as occupant sensors 132). The control panel 140 may track occupants in the building at different times of the day, different days of a week, and so forth. The control panel 140 may be connected to the lighting systems and/or the heating, ventilation, and air conditioning (HVAC) systems. The control panel 140 may adjust the lightings systems and/or the HVAC systems based on the number of occupants. For example, when the number of occupants in a first area increases above a first threshold, the control panel 140 may increase the air conditioning output to the first area. When the number of occupants in a second area decreases below a second threshold, the control panel 140 may reduce the lights in the second area and/or direct cleaning crews to the second area. The control panel 140 may adjust the lighting systems and/or the HVAC systems based on changes in the number of occupants or pre-emptively based on historical occupant information.

In a fourth example implementation, the control panel 140 may be placed in a building. The building may include a number of notification devices (such as notification devices 120) and a number of occupant sensors (such as occupant sensors 132). The control panel 140 may track occupants in the building at different times of the day, different days of a week, and so forth. The control panel 140 may display certain advertisement information (e.g., via the notification devices 120) when the number of occupants in an area exceeds a certain threshold.

In a fifth example implementation, a notification device 120-d may be outside the first zone 112 and the second zone 114. The notification device 120-d may be disposed at or near a border between the first zone 112 and a neighboring location. The current occupancy of the first zone 112 may exceed the corresponding threshold for the first zone 112. For example, the occupancy threshold limit of the first zone 112 may be 43, and the current occupancy of the first zone 112 may be 50. The notification device 120-d (which may not be in the first zone 112) may display and/or broadcast a message notifying people outside of the first zone 112 to not enter the first zone 112. For example, the notification device 120-d may display the following message: “Occupancy limit reached: Please do not enter.” In optional implementations, the notification device 120-a may display the occupancy threshold and/or the current occupancy. The notification device 120-d may be mounted on a wall, hung from the ceiling, an unmarked space between zones, and/or other suitable locations.

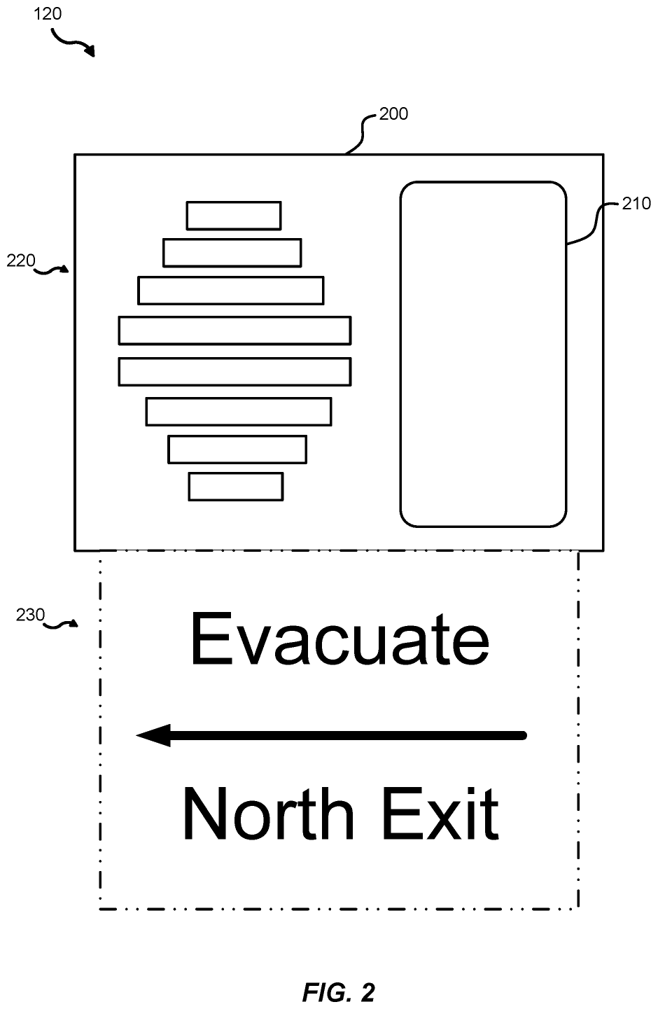

Referring to FIG. 2, an example of the notification device 120 may include an alarm notification device 200. The alarm notification device 200 may include a visual notification indicator 210 that provides visual notifications (e.g., strobe lights, flashing lights). The alarm notification device 200 may include a speaker 220 that broadcasts audio notifications. The notification device 120 may display messages in a display area 230 near the notification device 120, such as beneath the notification device 120. In other implementations, the display area 230 may be to the left, right, above and/or below the notification device 120 or in the notification device itself (not shown). In one example, the alarm notification device may display the message “Please Exit the Building,” “Maximum Capacity: 51,” or “Please Exit Through the Side Door Only.”

According to some aspects, the notification device 120 may display advertisements, public announcements, or other messages. In some instances, the notification device 120 may be displaying advertisements, public announcements, or other messages while the number of occupants of a zone changes from a state of being below the occupancy threshold to another state of exceeding the occupancy threshold. The control panel 140, upon determining that the number of occupants has exceeded the occupancy threshold, may interrupt and/or replace the display of advertisements, public announcements, or other messages by transmitting a message to the notification device 120 indicating that the number of occupants has exceeded the occupancy threshold and/or other relevant messages described above.

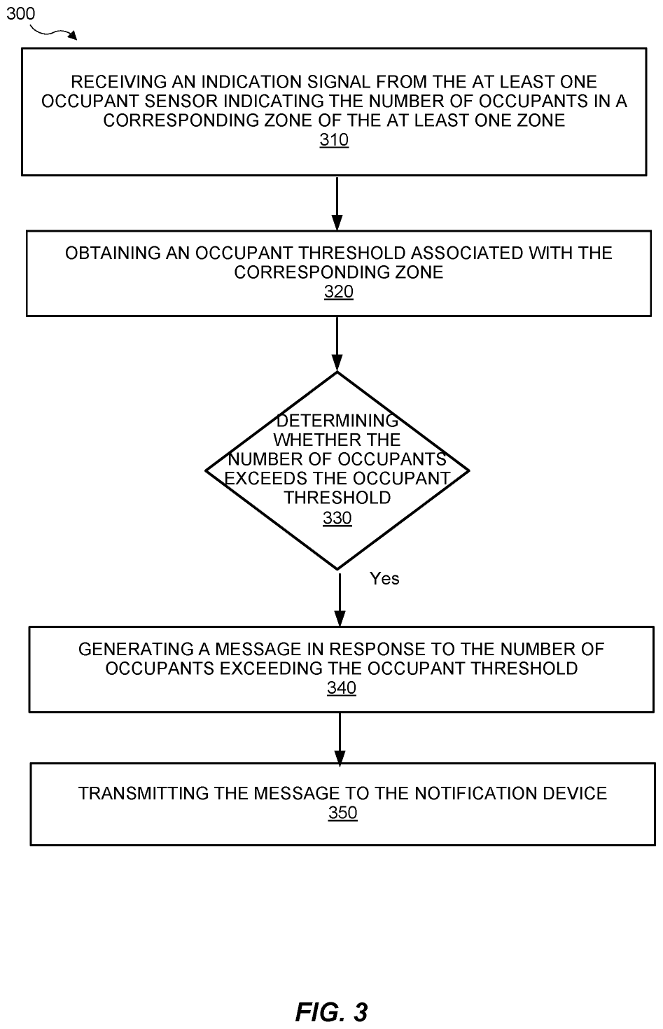

Referring to FIG. 3, an example of a method 300 for mass notification may be performed by the communication component 160, the occupancy component 162, the message component 164, and/or the control panel 140.

At block 310, the method 300 may receive an indication signal from the at least one occupant sensor indicating the number of occupants in a corresponding zone of the at least one zone. For example, the communication component 160 of the control panel 140 may receive an indication signal from one or more of the occupant sensor 130, 132, 134 indicating the number of occupants in a corresponding zone of at least one of the zones 112, 114 and/or the infrastructure, as described above. The communication component 160 and/or the control panel 140 may be configured to and/or define means for receiving an indication signal from the at least one occupant sensor indicating the number of occupants in a corresponding zone of the at least one zone.

At block 320, the method 300 may obtain an occupant threshold associated with the corresponding zone. For example, the occupancy component 162 of the control panel 140 may obtain the infrastructure occupant threshold associated with the infrastructure 101, the first occupancy threshold, and/or the second occupancy threshold from an internal memory of the control panel 140. Alternatively, the occupancy component 162 may obtain the thresholds from remote sources. The occupancy component 162 may be configured to and/or define means for obtaining an occupant threshold associated with the corresponding zone.

At block 330, the method 300 may determine whether the number of occupants exceeds the occupant threshold. For example, the occupancy component 162 of the control panel 140 may determine whether the number of occupants exceeds the occupant threshold as described above. The occupancy component 162 may be configured to and/or define means for determining whether the number of occupants exceeds the occupant threshold.

At block 340, the method 300 may generate a message in response to the number of occupants exceeding the occupant threshold. For example, the message component 164 of the control panel 140 may generate one or more of the messages 180, 182, 184 as described above. The message component 164 may be configured to and/or define means for generating a message in response to the number of occupants exceeding the occupant threshold.

In optional implementations, the method 300 may generate the message by selecting one or more existing messages stored in the control panel 140 and/or an internal/external memory of the control panel 140.

At block 350, the method 300 may transmit the message to the notification device. For example, the communication component 160 of the control panel may transmit one or more of the messages 180, 182, 184 to one or more of the notification devices 120 as described above. The communication component 160 may be configured to and/or define means for transmitting the message to the notification device.

In optional implementations, the method 300 may generate and/or transmit non-emergency messages for display.

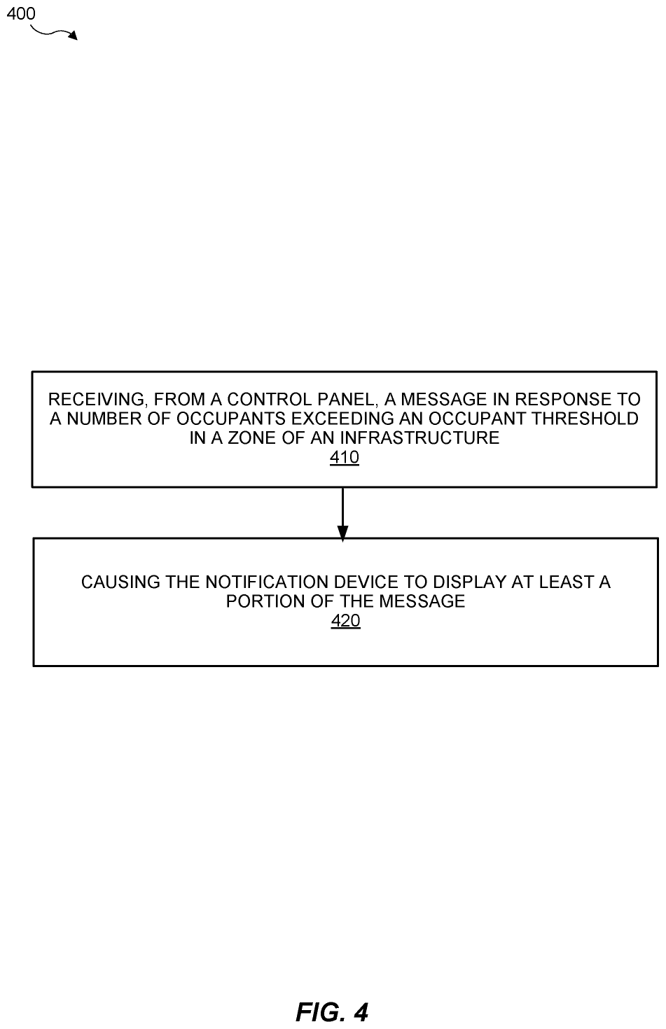

Referring to FIG. 4, an example of a method 400 for displaying a message may be performed by one or more of the message notification devices 120a-c.

At block 410, the method 400 may receive, from a control panel, a message in response to a number of occupants exceeding an occupant threshold in a zone of an infrastructure. For example, the notification device 320 may receive the message (e.g., the message 180, 182, 184) sent by the control panel 140 and/or the communication component 160 of the control panel 140 via the input link 316. The notification device 320 may be configured to and/or define means for receiving, from a control panel, a message in response to a number of occupants exceeding an occupant threshold in a zone of an infrastructure.

At block 420, the method 400 may cause the notification device to display at least a portion of the message.

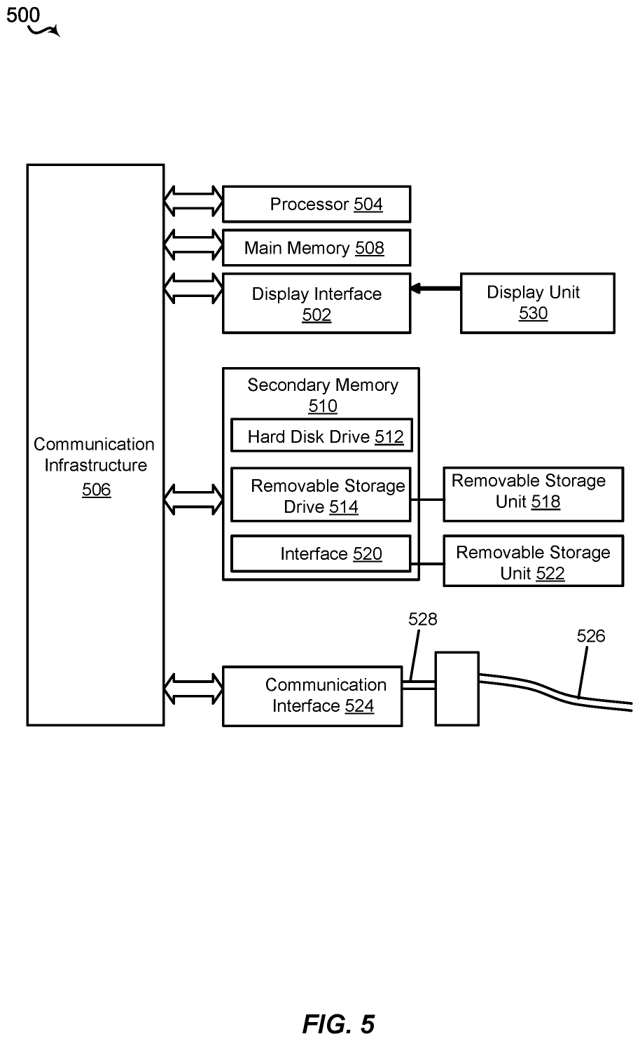

Aspects of the present disclosures, such as the control panel 140 and/or the notification device 320, may be implemented using hardware, software, or a combination thereof and may be implemented in one or more computer systems or other processing systems. In an aspect of the present disclosures, features are directed toward one or more computer systems capable of carrying out the functionality described herein. An example of such a computer system 500 is shown in FIG. 5. The control panel 140 and/or the PCM 320, may include some or all of the components of the computer system 500.

The computer system 500 includes one or more processors, such as processor 504. The processor 504 is connected with a communication infrastructure 506 (e.g., a communications bus, cross-over bar, or network). The term “bus,” as used herein, can refer to an interconnected architecture that is operably connected to transfer data between computer components within a singular or multiple systems. The bus can be a memory bus, a memory controller, a peripheral bus, an external bus, a crossbar switch, and/or a local bus, among others. Various software aspects are described in terms of this example computer system. After reading this description, it will become apparent to a person skilled in the relevant art(s) how to implement aspects of the disclosures using other computer systems and/or architectures.

The computer system 500 may include a display interface 502 that forwards graphics, text, and other data from the communication infrastructure 506 (or from a frame buffer not shown) for display on a display unit 530. Computer system 500 also includes a main memory 508, preferably random access memory (RAM), and may also include a secondary memory 510. The secondary memory 510 may include, for example, a hard disk drive 512, and/or a removable storage drive 514, representing a floppy disk drive, a magnetic tape drive, an optical disk drive, a universal serial bus (USB) flash drive, etc. The removable storage drive 514 reads from and/or writes to a removable storage unit 518 in a well-known manner. Removable storage unit 518 represents a floppy disk, magnetic tape, optical disk, USB flash drive etc., which is read by and written to removable storage drive 514. As will be appreciated, the removable storage unit 518 includes a computer usable storage medium having stored therein computer software and/or data. In some examples, one or more of the main memory 508, the secondary memory 510, the removable storage unit 518, and/or the removable storage unit 522 may be a non-transitory memory.

Alternative aspects of the present disclosures may include secondary memory 510 and may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528, which may be electronic, electromagnetic, optical or other signals capable of being received by communications interface 524. These signals 528 are provided to communications interface 524 via a communications path (e.g., channel) 526. This path 526 carries signals 528 and may be implemented using wire or cable, fiber optics, a telephone line, a cellular link, an RF link and/or other communications channels. In this document, the terms “computer program medium” and “computer usable medium” are used to refer generally to media such as a removable storage drive 518, a hard disk installed in hard disk drive 512, and signals 528. These computer program products provide software to the computer system 500. Aspects of the present disclosures are directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features in accordance with aspects of the present disclosures, as discussed herein. In particular, the computer programs, when executed, enable the processor 504 to perform the features in accordance with aspects of the present disclosures. Accordingly, such computer programs represent controllers of the computer system 500.

In an aspect of the present disclosures where the method is implemented using software, the software may be stored in a computer program product and loaded into computer system 500 using removable storage drive 514, hard drive 512, or communications interface 520. The control logic (software), when executed by the processor 504, causes the processor 504 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A notification system in an infrastructure, comprising:
a control panel;
at least one occupant sensor communicatively coupled with the control panel and configured to determine a number of occupants in each of at least one zone in the infrastructure; and
a notification device mounted on a surface and communicatively coupled with the control panel;
wherein the control panel is configured to:
receive an indication signal from the at least one occupant sensor indicating the number of occupants in a corresponding zone of the at least one zone,
obtain an occupant threshold associated with the corresponding zone,
determine whether the number of occupants exceeds the occupant threshold,
generate a message in response to the number of occupants exceeding the occupant threshold,
transmit the message to the notification device; and
wherein the notification device is configured to:
receive the message from the control panel, and
display at least a portion of the message.

2. The notification system of claim 1, wherein the at least one occupant sensor is a passive infra-red detector, an imaging camera, a horizontal beam sensor, or a turnstile counter.

3. The notification system of claim 1, wherein the message is one of a plurality of messages including at least one of a warning message, a direction to an exit, a direction to a different zone, or an overflow number.

4. The notification system of claim 3, further comprising a plurality of notification devices, wherein at least two of the plurality of notification devices receive different messages of the plurality of messages.

5. The notification system of claim 4, wherein each of the plurality of notification devices is further configured to display the corresponding message it receives.

6. The notification system of claim 5, wherein a first subset of the plurality of notification devices includes retrofitted devices and a second subset of the plurality of notification devices includes standalone devices.

7. The notification system of claim 1, wherein the control panel is further configured to:
generate a non-emergency message; and
transmit the non-emergency message to the notification device.

8. The notification system of claim 7, wherein the control panel is further configured to suspend transmission of the non-emergency message in response to the number of occupants exceeding the occupant threshold.

9. The notification system of claim 1, wherein the notification device comprises at least one of a strobe light, a siren, or an audio speaker or projector.

10. The notification system of claim 1, wherein:
each of the at least one occupant sensor includes a corresponding identifier,
the indication signal includes the corresponding identifier of the at least one occupant sensor transmitting the indication signal, and
the control panel is further configured to identify the at least one zone based on the identifier in the indication signal.

11. A method, comprising:
receiving an indication signal from at least one occupant sensor indicating a number of occupants in a corresponding zone of at least one zone;
obtaining an occupant threshold associated with the corresponding zone;
determining whether the number of occupants exceeds the occupant threshold;
generating a message in response to the number of occupants exceeding the occupant threshold; and
transmitting the message to the notification device for displaying via the notification device.

12. The method of claim 11, further comprising:
generating a non-emergency message; and
transmitting the non-emergency message to the notification device for displaying via the notification device.

13. The method of claim 12, further comprising:
suspending transmission of the non-emergency message in response to the number of occupants exceeding the occupant threshold.

14. A notification system in an infrastructure, comprising:
a control panel; and
a notification device communicatively coupled with the control panel;
wherein the control panel is configured to:
receive an indication signal from at least one occupant sensor indicating a number of occupants in a corresponding zone of at least one zone in the infrastructure,
obtaining an occupant threshold associated with the corresponding zone,
determining whether the number of occupants exceeds the occupant threshold,
generating a message in response to the number of occupants exceeding the occupant threshold, and
transmit the message to the notification device; and
wherein the notification device is configured to:
receive the message from the control panel, and
display at least a portion of the message.

15. The notification system of claim 14, wherein the message is one of a plurality of messages including at least one of a warning message, a direction to an exit, a direction to a different zone, or an overflow number.

16. The notification system of claim 14, further comprising a plurality of notification devices, wherein at least two of the plurality of notification devices receive different messages of the plurality of messages.

17. The notification system of claim 16, wherein the plurality of notification devices are further configured to each display the corresponding message it receives.

18. The notification system of claim 17, wherein a first subset of the plurality of notification devices includes retrofitted devices and a second subset of the plurality of notification devices includes standalone devices.

19. The notification system of claim 14, wherein:
the control panel is further configured to:
generate a non-emergency message, and
transmit the non-emergency message to the notification device; and
the notification device if further configured to display at least a portion of the non-emergency message on the surface.

20. The notification system of claim 14, wherein the notification device comprises at least one of a strobe light, a siren, or an audio speaker or a projector.
